(19) United States
(12) Patent Application Publication
(10) Pub. No.: US 2021/0213638 A1
(43) Pub. Date: Jul. 15, 2021

(54) STRAPPING CUTTER

(71) Applicant: LUMILEDS HOLDING B.V., Schiphol (NL)

(72) Inventors: Martin CZAJA, Sprockhoevel (DE); Christian NOELKE, Duesseldorf (DE)

(21) Appl. No.: 17/059,388

(22) PCT Filed: Jun. 7, 2019
(86) PCT No.: PCT/EP2019/065307

§ 371 Date: Nov. 27, 2020

(30) Foreign Application Priority Data
Jun. 19, 2018 (EP) 1817446.3

(51) Int. Cl. B26F 1/14; B26F 1/40; B26F 1/44

(52) U.S. Cl. CPC B26F 1/14; B26F 1/44; B26F 1/40

(57) ABSTRACT

The invention describes an LED lighting assembly (1) comprising a reflector unit (11) comprising a number of reflector regions (11_lo, 11_hi); an LED carrier (10) realised to support at least one LED arrangement (2_lo, 2_hi); and at least one positioning feature (P_{χ}, P_{γ}, P_{Z}) for positioning the LED carrier (10) relative to the reflector unit (11), wherein a positioning feature (P_{χ}, P_{γ}, P_{Z}) is arranged in the same plane as the optical centre of the LED arrangement (2_lo, 2_hi). The invention further describes a method of manufacturing such an LED lighting assembly (1).

The invention relates to a band cutter for strapping, comprising a movable pusher element, a foot with a pushing edge for the strapping that can be fixed between the foot and the pusher element, and a cutting blade for severing the fixed strapping band.

Band cutters for strapping are used in a variety of ways to make strapped goods accessible. In the simplest case, such cutters can be a pair of scissors with a movable and a fixed blade. In addition, a clamp is usually provided to hold the severed strip. This is necessary inasmuch as such severed strips often involve considerable spring “jump back” and thereby damage or in the worst case, they can even cause injuries to operating personnel. Typical examples of such devices for severing a strip of strapping band are described in EP 1 495 978 [U.S. Pat. No. 7,913,599].

In the generic prior art according to EP 3 013 538 [U.S. Pat. No. 9,630,265], a battery-operated band cutter is seen. This has a pressure device that can be moved into contact with the strapping. In this way, the band can be stabilized against a foot. While the pressure device holds down the band, an additionally provided cutting blade cuts the band on a pushing edge. That has basically been preserved.

In addition, the prior art according to U.S. Pat. No. 8,160,748 describes the possibility of moving such a cutter with the aid of a three-dimensional robot arm. In order to position the cutter, a band detector is also provided. In that case, this is a camera.

However, the known band cutters for strapping are associated with the disadvantage that, in particular, steel strapping bands that are quite thick, such as those used for wrapping and holding together strip-metal coils, can practically not be cut or with such a strapping cutter since it cannot be ensured that when it is severed end it does not pop open in an uncontrolled manner despite any provided clamping devices.

This is because the known clamping devices ultimately ensure that the steel strips in question are gripped, for example with the aid of friction surfaces, as are used by way of example in the further prior art according to WO 2008/052175. However, such friction surfaces fail in the field of application described, because, for example, steel strips for strapping metal strip coils can have pretension of 40 to 50 kN or even more. Such pretensioned bands can practically not be controlled with conventional gripping devices, so that the previously known cutters fail in the described field of application. The invention aims to provide a remedy here overall.

The object of the invention is to provide such a band cutter for strapping that securely and reliably prevents the severed strapping from escaping and securely holds the severed end of the strapping.

In order to attain this object, a generic cutter for strapping is within the scope of the invention characterized in that the pusher element is formed as a punch that at least partially penetrates the strapping.

In the context of the invention, in contrast to the prior art according to EP 3 013 538, the pusher element not only ensures that the strapping is held between the foot and the pusher element. Rather, the pusher element penetrates more or less into the strapping as a punch and thereby ensures a pronounced punching in the strapping. As a result of this punching and a punch-out produced by the punch in the strapping band, the severed end of the strapping band is in effect not held by frictional forces. Rather, the punch-out extending wholly or partially from the strapping ensures that the severed end of the strapping is held in place like a claw with the aid of the punch. In this way, the previously mentioned pretensioning can be controlled in such strapping bands in the strapped state, at levels of 50 kN and even more. This is not possible with the cutters made available so far.

In fact, the band cutter for strapping bands according to the invention opens up the option of being able to cut thick and high-strength strapping bands (made of steel) for the first time. Such so-called high-performance bands have tensile strengths of 1200 N and more, for example. In addition, breaking loads of more than 50,000 N or 50 kN and even up to 57 kN are observed for such high-performance bands that are consequently equipped with a material thickness greater than that of the steel bands of, for example, 1.4 mm and more. As a result of the use of high-strength steel, special requirements are placed on cutters that are not met by the cutters known in the prior art but that can, on the other hand, be cut through properly and safely for the first time using the solution according to the invention.

According to an advantageous embodiment, the design is made such that the foot has a recess for the punch. As a result, when it passes through the strapping band, the punch creates the previously mentioned punch-out that, either alone or together with the punch, extends into the recess in the foot when it is formed. At the same time, the recess together with the punch and the punch-out in the recess provide additional support for the severed end of the strapping band. This reliably prevents the severed strapping band, in particular steel band, from escaping, and any damage or even health hazards for operating personnel can be reliably prevented.

The punch can have very different shapes and cross-sectional designs. As a rule, the punch is of polygonal cross section. Trapezoidal, square, hexagonal, octagonal or other polygonal shapes can be implemented and realized here. It is also conceivable for the punch to be oval or round in cross section. In principle, such combinations are conceivable.

A design of the punch that has a triangular cross-section has proven particularly advantageous. Because this allows any expansion forces of the strapping to be cut to be absorbed particularly well. In fact, such expansion forces generally act along the axis of symmetry of the relevant triangle and are thereby over the respective legs of the triangle is introduced evenly into the punch, which in turn is not overloaded in this way.

The punch also has a point projecting in the direction of pressure and an adjoining stop shoulder. Because the point of the punch projects, it ensures that the point penetrates the strapping band can go through it. As a rule, the point is located at the apex of the strapping band [punch], which is triangular in cross-section, so that the apex point can penetrate the strapping band particularly easily and effectively and cut it in the area of this apex point. At the same time, the angled stop shoulder that adjoins the projecting point ensures that the punch-out that is formed in this way is bent into the strapping from a surface of the band.

Thus, the punch-out is still connected to the strapping at its base opposite the apex of the triangle. As a result, the base of the triangular punch-out can be bent over against the surface of the band, with the help of the stop shoulder. The punch-out formed in this way is thus of triangular shape following the shape of the punch and is connected to the strapping band with the base of the triangle. At the same time, the punch-out is bent toward the surface of the band and as a result, more or less pronouncedly dips into the recess in the foot. In any case, the punch, the punch and the recess in the foot ensure that the severed end of the strapping is properly held and is only released by the severing device when the punch is returned to its original position.

The punch is generally arranged approximately in the middle of the foot. The cutting blade is usually an upper cutting edge that works together with a foot edge as a lower cutting edge. Thus, one edge of the foot functions as a lower cutting edge while the cutting blade takes on the function of the upper cutting edge in the scissors or metal shear realized in this way. In this way, cutting angles can be introduced into the strapping to be severed, which are fundamentally variable and, for example, are or can be values in the range from 1° to 50°, based for example on the transverse direction of the band.

The punch and the cutting blade are each for the most part moved vertically relative to the foot or are correspondingly designed to be vertically movable compared to the foot. For this reason, a ram can be provided to act on both the punch and the cutting knife. In this connection, the design is usually made such that the punch is equipped with a projection opposite the cutting knife and, taking this projection into account, is connected to the ram together with the cutting knife. The projection ensures that the punch first penetrates completely or partially into the strapping band and in this way holds the end of the strapping band to be severed subsequently. Only when the punch has fully or partially penetrated the strapping does the cutting knife, as an upper cutting edge, in conjunction with the foot edge as a lower cutting edge, ensure the desired cutting process and the severing of the strapping.

The punch and/or the cutting knife are generally mounted on a common support flange. The support flange also guides the ram. For this purpose, the punch and the cutting knife are oriented opposite in comparison to the support flange in the middle. In addition, the punch or the cutting knife can be mounted floating above the support flange. In principle, the support flange as a whole can have a floating bearing opposite a machine frame. As a result, when the punch penetrates the strapping and due to its tensile stress, overall reduced shear forces act on the punch. The same may apply to the cutting knife. As a rule, however, it is mainly the punch that is gloatingly mounted opposite the support flange. For this purpose, one or more springs are generally provided which on the one hand provide unaltered linear guidance of the punch with the aid of the support flange, but on the other hand allow the punch to move sideways.

In addition, a band detector is provided for position detection in relation to the strapping to be cut. Thus, with the help of the band detector, the above-described band cutter according to the invention is aligned with respect to the strapping to be cut. Such a position detection and band detector is particularly recommended for the case that the band cutter works in a stationary manner and is connected, for example, to a robot arm or generally to a three-dimensionally displaceable adjusting device. For mobile use of the band cutter, which is also possible, such a band detector is of course not absolutely necessary because the positioning of the band cutter is carried out by an operator.

The band detector is usually designed as a laser-type detector. With the aid of the laser-type detector, for example, the surface of a metal strip coil strapped with a steel band is scanned. The strapping appears on this surface as a rectangular elevation, which can be determined via the laser-type detector and at this point by distance measurements. This allows the position of the strapping to be determined and the band cutter to be precisely aligned. In addition, after the position of the strapping has been determined, the cutter is usually pushed down with the foot under the tensioned strapping with the help of the three-dimensional adjusting device so that the pushing edge formed on the foot ensures that the strapping can be lifted from the strapped material and the foot can be pushed under it. Only then does the separation process described above in detail take place.

For the drive of the punch and the cutting knife, all drive forms that are basically possible in this context can be used. In fact, a hydraulic and/or pneumatic and/or electric drive is conceivable at this point. If an electric drive is used, it can work with AC voltage from the mains. However, it is also possible to use battery operation for portable use. Consequently, the cutter can be designed to be mobile or stationary overall.

As a result, a band cutter for strapping is provided that works particularly safely and reliably. This also applies, and in particular, to strapping with steel bands subject to particularly high tension during the cutting process, as is observed, for example with steel strapping bands used for strapping strip-metal coils can be used. In the case of strapping bands of this type, the band cutter implemented according to the invention ensures that the severed end of the strapping band in question cannot spring open in an uncontrolled manner and cause damage or injury to operating personnel. This is not possible with previously known cutters used in practice. This is where the main advantages can be seen.

In the following, the invention is described in more detail with reference to a drawing showing only one embodiment. Therein:

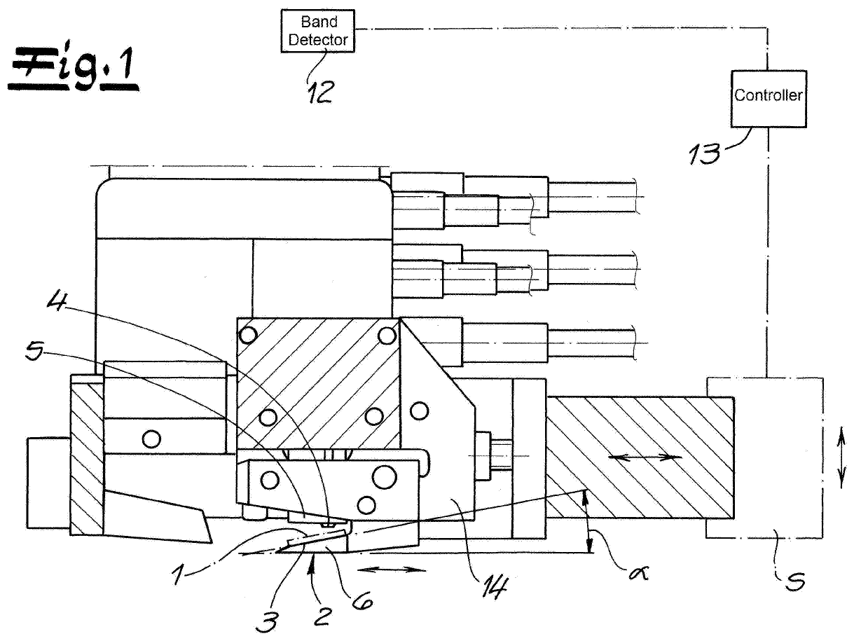

FIG. 1 is an overview of a strapping cutter,

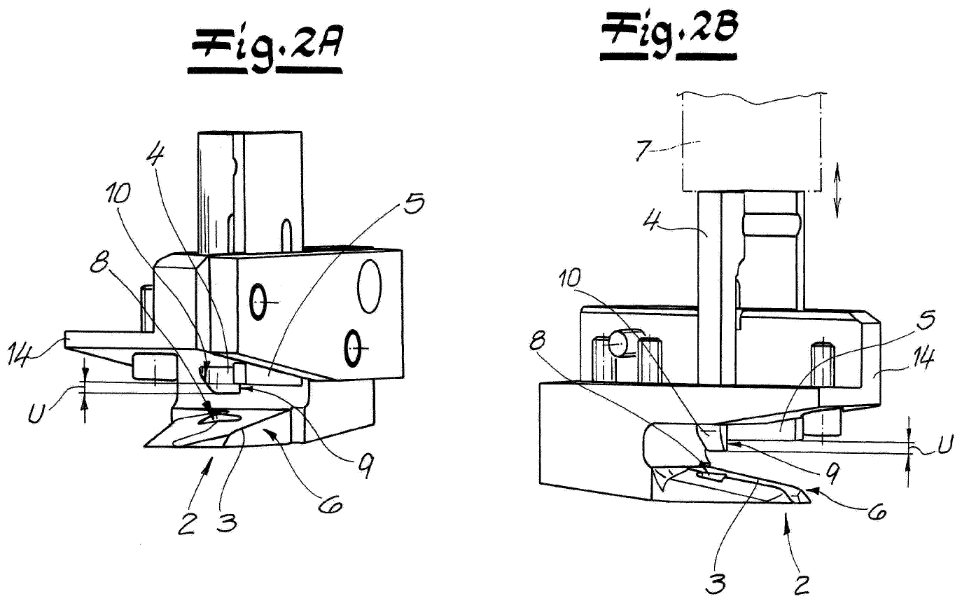

FIGS. 2A to 2D show details of the cutter according to FIG. 1 from different angles, and

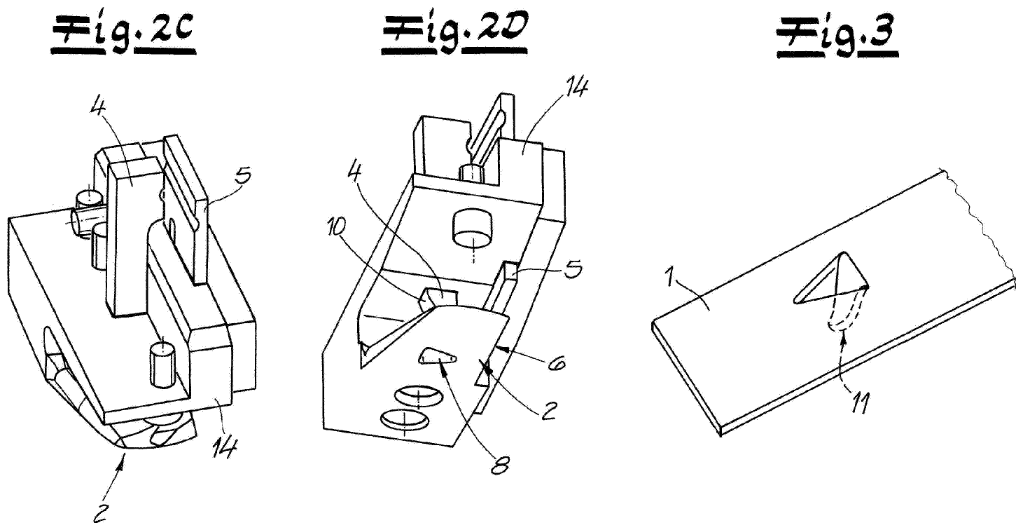

FIG. 3 shows the severed end of the strapping band with the punch-out.

The drawing shows a band cutter that can cut a strapping band indicated at 1 in FIG. 1. The strapping bands 1 are mostly steel strapping bands. The invention is of course not restricted to this. According to the embodiment, the steel band or strapping band 1 in question is looped around strip-metal coils, which are not shown in detail, and have to be cut for further processing of the strip-metal coils. For this purpose as shown in FIG. 1 a foot 2 of the cutter with a pushing edge is pushed under the tensioned strapping band 1 in the direction shown by a double arrow in FIG. 1. To this end, the cutter shown in the overview in FIG. 1 is carried on a three-dimensional actuating device 5 shown schematically in FIG. 1. The actuating device 5 is advantageously a robot arm. Of course, this is only an example. In addition, the actuating device 5 can in principle be dispensed with in the event that the cutter is designed to be mobile and is manipulated by an operator.

In any case, the actuating device 5 shown in FIG. 1 ensures that the cutter, which is to be described in detail below, is pushed under the tensioned strapping 1 with its foot 2. The wedge shape of the pushing edge 3 ensures that this process can be carried out and the tensioned strapping 1 is increasingly lifted off the strapped material. For this purpose, the sliding edge 3 may have an angled upper face indicated in FIG. 1 and forming with respect to a horizontal line an angle α of approximately 10°. Typically, angles of inclination a between 5° and 20° are observed. Of course, this is not restrictive. The angle α also corresponds to a cutting angle when the strapping band 1 is severed, which is still to be described.

In particular, the detailed views of FIGS. 2A to 2D now show the foot 2 with the pushing edge 3 and additionally a pusher element 4 and a cutting blade 5. Using the pusher element 4, the strapping 1 can be gripped between the foot 2 and the pusher element 4. This fixation ensures that, during a cutting process with the aid of the cutting blade 5, the tensioned strapping 1 does not spring open after cutting and that the end of the strapping 1 that has been cut through by the cutting blade 5 is held in place.

The cutting blade 5 for severing the fixed strapping 1 an upper cutting edge during this process. An edge 6 on the foot 2 takes on the function of a lower cutting edge 6. In this way, the movable cutting blade 5 and the foot edge 6 define a pair of metal scissors 5, 6 or shears 5, 6, provided that the strapping 1 is a steel band. Both the cutting blade 5 and the pusher element 4 are for the most part designed to be movable vertically compared to the foot 2, as indicated by a double arrow in FIG. 2B. According to this embodiment, a common and schematically indicated ram 7 moves the pusher element 4 and the cutting blade 5. The punch 7 can also be a cylinder. In any case, the ram 7 executes the traversing movements shown in FIG. 2B vertically in comparison to the foot 2. A hydraulic drive may provide for the drive of the ram 7 or a cylinder at this point.

According to the invention, the pusher element 4 is formed as a punch that at least partially penetrates the strapping 1. According to the embodiment, the punch 4 is one of triangular cross-section. Consequently, the foot 2 has a complementary recess 8 that is also triangular and is adapted to the shape of the triangular punch 4. As a result, the punch 4 as a whole can penetrate the strapping band 1 or at least partially penetrate it and dip into the recess 8 in the foot 2.

The punch 4 is equipped on the foot side with a point 9 projecting in the pressing direction or the direction of travel of the punch 4 according to the double arrow in FIG. 2B. In addition to the projecting point 9 to a rearwardly angled stop shoulder 10. The projecting point 9 is provided in the region of an apex of the triangle of the triangular cross-sectional shape of the punch 4. In contrast, the stop shoulder 10 extends in the direction of a base side of the triangle in question opposite the apex.

In this way, the punch 4 penetrating into the strapping 1 forms a punch-out 11 in the strapping 1 as shown in FIG. 3. This punch-out 11 in the strapping 1 is created in that the punch 4 with its projecting point 9 cuts through the strapping 1. Since the stop shoulder 10 angled back from the projecting point 9, opposite the point 9, the punch-out 11 is connected to the strapping 1 at the base of its triangle. In this way, the stop shoulder 10, which adjoins the projecting point 9, bends the punch-out 11 with respect to a band surface of the strapping band 1.

The bent punch-out 11 can more or less dip into the recess 8 in the foot 2 during this process. In this way, the punch 4, the bent punch-out 11 and the recess 8 in the foot 2 taken together ensure that the subsequently severed end of the strapping 1 is securely held by the severing device. This is because the punch 4 penetrating into the strapping band 1 functions like a claw dipping into the strapping band 1 and ensures a secure hold.

The punch 4 is arranged approximately centrally in the foot 2. The same applies to the recess 8 in the foot 2 that interacts with the punch 4. It can also be seen from the detailed views of in FIGS. 2A to 2D that the punch 4 of the ram 7 extends by a distance U past the knife 5. This dimension U is such that when the ram 7 acts, the punch 4 first penetrates the strapping 1 and forms the bent punch-out 11 as shown in FIG. 3. As a result, the end of the strapping 1 that is to be severed subsequently is securely held. Only after this fixing of the end of the strapping 1 to be severed does the cutting blade 5 sever the strapping 1. For this purpose, the cutting blade 5 and the foot edge 6 define the cutting shear 5, 6 described above. A support flange 14 for the common mounting of the punch 4 and the cutting knife 5 ensures their proper linear guidance.

In order to detect the position and align the described cutter with respect to the strapping band 1 holding the material to be strapped, a band detector 12 can be provided as indicated schematically in FIG. 1. The band detector 12 works in the present case as a laser-type detector, as has already been described above. To control the three-dimensional positioner S, a common controller 13 is provided that processes corresponding measured values from the band detector 12 and controls the positioner S accordingly, so that it can move the foot 2 to cut the strapping 1 and thus the band cutter as a whole.

A pneumatic motor or an electric drive can be used to drive the ram 7. If an electric drive is used, it can be operated with mains voltage or alternating voltage, for example. Mobile use is also possible with a battery-operated electric drive possible and is covered by the invention. Consequently, the cutter can be designed to be mobile as a hand-held device or as a stationary device in conjunction with the actuating device S described and operating in three dimensions. Both are expressly possible.

A comparison of FIGS. 2A to 2D shows that the punch 4 and the cutting knife 5 are mounted on the common support flange 14. The support flange 14 provides the desired linear guidance of both the punch 4 and the cutting knife 5. In addition, a floating mounting can be implemented in this connection. In fact, according to the embodiment, the procedure is such that the support flange 14 allows a lateral movement of the punch 4 by means of, for example, springs attached on both sides and not shown in detail, that is in the longitudinal direction of the strapping 1. This cushions the wall force exerted by the strapping 1 on the punch 4. As a result of this, any shearing forces acting on the punch 4 are reduced.

1. A cutter for a strapping band, the cutter comprising:
a pusher element movable in a direction,
a wedge foot with a pushing edge for the strapping band that can be fitted between the foot and the pusher element, and
a cutting blade on the pusher element and movable in the direction therewith past the pushing edge for severing the fixed strapping band, and
a punch on the pusher element and projecting in the direction past the cutting blade for at least partially penetrating the strapping band.

2. The cutter according to claim 1, wherein the foot has a recess in which the punch is engageable.

3. The cutter according to claim 1, wherein the punch is polygonal in cross-section.

4. The cutter according to claim 1, wherein the punch has a point projecting in the pressing direction and an adjoining angled stop shoulder.

5. The cutter according to claim 4, wherein, on movement of the pusher element in the direction to cut the band, the projecting point penetrates into the strapping band and the shoulder adjoining it bends a punch-out part formed as a result relative to a band surface.

6. The cutter according to claim 1, wherein the punch is approximately in the middle of the foot.

7. The cutter according to claim 1, wherein the cutting blade interacts with a cutting edge foot edge on the foot as a lower cutting edge.

8. The cutter according to claim 1, wherein the punch and the cutting blade are movable partially vertically in comparison to the foot.

9. The cutter according to claim 8, further comprising:
a ram for acting on the punch for and the cutting knife.

10. The cutter according to claim 9, wherein the punch is connected to the ram with a projection opposite the cutting knife.

11. The cutter according to claim 1, wherein the punch and/or the cutting knife are floatingly mounted on a common support flange.

12. The cutter according to claim 1, further comprising:
a band detector position detection of the strapping band to be severed.

13. The cutter according to claim 12, wherein the band detector is a laser-type detector.

14. The cutter according to claim 9, further comprising:
a hydraulically and/or pneumatically and/or operating with mains voltage or battery drive for the ram.

15. The cutter according to claim 1, wherein the cutter is mobile or stationary.

16. A cutter for a strapping band, the cutter comprising:
a support;
a wedge foot carried on the support and engageable under the band and formed with a lower cutting edge and thereadjacent a recess open toward the support;
a pusher element on the support displaceable in a direction toward and away from the foot;
a blade carried on the pusher element, having an upper cutting edge, and movable past the lower cutting to cut the band between the upper and lower cutting edges; and
a punch carried on the pusher element and projecting in the direction toward the foot and past the upper cutting edge and engageable in the recess such that, prior to cutting the band between the cutting edges, the punch penetrates through the band into the recess to arrest the band in the cutter.
